(19) United States
(12) Patent Application Publication
(10) Pub. No.: US 2005/0111648 A1
(43) Pub. Date: May 26, 2005

(54) Multi-stage telephone number dialing system and method for providing limited access to a telephone subscriber

(76) Inventor: William D. Roome, Murray Hill, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/722,784

(22) Filed: Nov. 26, 2003

(51) Int. Cl. H04M 3/42

(52) U.S. Cl. 379/210.02; 379/211.02; 379/207.13

(57) ABSTRACT

A multi-stage telephone number dialing system and method of “semi-listed” numbers provides limited and selective access of individuals to a telephone subscriber. When a semi-listed number is called, a recorded announcement is played to the caller requesting that the caller enter an authorization code or “PIN” (Personal Identification Number). One of a number of possible actions is then performed based on the entered PIN, illustratively determined by a database lookup. Actions which may be taken include (i) connecting the incoming call through to the subscriber, (ii) directing the incoming call to a voice mailbox, (iii) providing a recorded message to the caller, and (iv) disconnecting the call.

### FIELD OF THE INVENTION

The present invention relates generally to the field of telecommunications and more particularly to a multi-stage telephone number dialing system and method for providing limited access to a given telephone subscriber.

### BACKGROUND OF THE INVENTION

Unlisted (or “unpublished”) telephone numbers have for a long time been available to telephone subscribers who wish to limit access to their telephone lines by the general public, and who want to be able to control who is able to call them. Typically (and often for a modest charge), a telephone subscriber may request from his or her telephone service provider that his or her assigned telephone number remain unpublished so that access can be easily limited to only those people that the subscriber wishes to have such access—that is, those people to whom the subscriber explicitly reveals his or her number.

Although such unlisted telephone numbers do, in general, provide some degree of desired privacy, they are vulnerable to “compromise” in that once the number has been given out, there is no further control over access to the corresponding telephone line. In other words, once the phone number is known, that knowledge cannot be “revoked,” and so, if the number becomes known (accidentally, for example) to anyone other than those people that the subscriber wishes to have access, the only recourse is to completely cancel the telephone number with the service provider and replace it with a new one. Similarly, if the relationship between the subscriber and a person who previously had access (i.e., knew the telephone number) changes, and the subscriber wishes that person to no longer have access, there is nothing short of changing the telephone number entirely that can be done.

In addition, neither conventional listed telephone numbers nor conventional “unlisted” telephone numbers provide the subscriber with any ability to distinguish “classes” of potential callers (i.e., people). That is, all callers who know the telephone number are necessarily treated essentially the same. For example, there is no way that the subscriber can require some callers to leave a voicemail message but answer (i.e., personally “pick up”) the call from other callers based on the identity of the caller.

Note that conventional “caller ID” mechanisms (also known as Automatic Number Identification or “ANI”) do in fact allow the calling number, and/or a name associated with the number, to be identified and reported to the called party, thereby allowing the subscriber to make a decision as to what action to take based on the identified number (or the name associated with the number). For example, based on the calling number (or name), the subscriber may choose to accept the call, or alternatively, may choose to “force it” to go to the voicemail system instead. However, such “caller ID” based approaches to call classification not only require the subscriber to be “in the loop,”-but moreover, they are by definition based only the calling number and not on the individual person who is calling. This prevents the same advantageous result (i.e., call classification) from occurring regardless of the particular telephone from which a given person is calling. In other words, a classification based on the identity of the individual caller cannot be made automatically with use of such “caller ID” based techniques.

### SUMMARY OF THE INVENTION

In accordance with the principles of the present invention, a multi-stage telephone number dialing system and method provides limited and selective access of individuals to a given telephone subscriber. Moreover, in accordance with these principles, such limited access may advantageously be modified quite easily by the subscriber at any time. In particular, a technique which will be generally referred to herein as “semi-listed” telephone numbers provides such an easily modifiable, selective, multi-stage access to a telephone subscriber's telephone line.

More specifically, in accordance with one illustrative embodiment of the present invention, a conventional telephone number is assigned by a service provider to a subscriber. However, when a caller calls that number, instead of (immediately) ringing the subscriber's telephone, an “interception module” advantageously intercepts the call. This interception module, in accordance with various illustrative embodiments of the present invention, may comprise either hardware, software, or both, and may be located either on the customer's premises or “within the network” (e.g., in the service provider's plant). In any case, the interception module advantageously causes a recorded announcement to be played to the caller (which may, for example, be configurable by the customer), and then waits for the caller to enter an authorization code or “PIN” (Personal Identification Number). In accordance with various illustrative embodiments of the present invention, the caller can enter the requested code either with use of the telephone keypad or by voice.

In accordance with the illustrative embodiment of the present invention, the interception module determines one of a number of possible actions to perform based on the entered authorization code. For example, if the caller fails to enter a valid code (preferably after a number of attempts or after a predetermined period of time), the interception module may cause a “default” action to be taken (specified, for example, by the subscriber). However, if the caller enters a valid code, that code may, for example, be looked up in a database to determine an appropriate action to take. In accordance with various illustrative embodiments of the invention, some of the various actions which may be taken (including the “default” action) include (i) connecting the incoming call through to the subscriber, (ii) directing the incoming call to a voice mailbox, (iii) providing a recorded message to the caller, and (iv) merely disconnecting the call.

### BRIEF DESCRIPTION OF THE DRAWINGS

FIG. 1 shows tan example telecommunications network in which an illustrative embodiment of the present invention may be advantageously implemented.

FIG. 2 shows a flowchart specifying a method for performing caller classification in accordance with an illustrative embodiment of the present invention.

### DETAILED DESCRIPTION OF THE ILLUSTRATIVE EMBODIMENTS

In accordance with an illustrative embodiment of the present invention, a telephone service provider (SP) initially assigns a telephone number to a subscriber. However (unlike a conventional telephone number), when a caller calls that number, an interception module advantageously intercepts the call. As pointed out above, this interception module may, in accordance with various illustrative embodiments of the invention, be software, hardware or a combination of the two, and it may exist either at the customer's premises or in the network (e.g., at the service provider's plant). In particular, the interception module may then play a prerecorded announcement message (which may, for example, have been configured by the subscriber) to the caller, and then, in accordance with the principles of the present invention, waits for the caller to enter an authorization code or PIN (Personal Identification Number). (Note that the terms “authorization code” and PIN may be used interchangeably herein, but both are intended to refer to any string of digits, letters and/or other characters, which may be used to identify the particular caller to the interception module.) Then, the caller enters his or her authorization code, which, in accordance with various illustrative embodiments of the present invention, may be provided via a telephone (e.g., the phone being used to place the call) keypad, a computer terminal (if, for example, the call is being made from a computer with use of voice-over-IP or similar computer-based calling techniques, familiar to those of ordinary skill in the art), or by spoken voice.

Once the authorization code has been received, the interception module takes the action that the subscriber has configured for that particular code. For example, in accordance with one illustrative embodiment of the invention, the interception module looks up the code in a previously populated database which contains each “valid” (e.g., defined by the subscriber) code and the indication of a corresponding action to be taken in response thereto. In addition, the database may specify (or, alternatively, the interception module may contain as a “hard-wired” feature) a “default” action to be taken if no code is entered or if the code entered is not “valid” (for example, does not appear in the database). Note that the interception module may advantageously allow the caller either a predetermined number of tries or a predetermined period of time to enter a valid code, before deciding to take the “default” action. Note also that the default action may be specified by and configurable by the subscriber.

In accordance with various illustrative embodiments of the invention, any of a number of possible actions may be selected based on the entered authorization code (or the lack of a valid entered code). For example, the selected actions may include (i) connecting the caller (i.e., “ringing through”) to the subscriber, optionally with a distinctive ring which may, for example, be based on the particular authorization code which has been entered; (ii) redirecting the incoming call to a voice mailbox, optionally preceded by the playing of a prerecorded announcement, wherein the voice mailbox may be selected from a plurality of possible mailboxes based on the entered authorization code (or on the fact that no valid code was entered); (iii) providing a recorded message to the caller, and then disconnecting the call; and/or (iv) merely disconnecting the call (i.e., hanging up on the caller).

In accordance with certain illustrative embodiments of the present invention, the subscriber may define and redefine authorization codes and assign and reassign these codes to particular actions as often as desired. In general, the subscriber will at least provide an initial set of codes along with corresponding actions therefor when the semi-listed telephone number is initially assigned, although these initial default values (and actions) may also be provided by the service provider. In certain ones of these illustrative embodiments, the subscriber advantageously uses an Internet-based (e.g., web-based) system for configuring and reconfiguring authorization codes and their corresponding actions. In other embodiments, the subscriber's conventional telephone may be used to enter this data, either with use of the telephone keypad or through a spoken voice. Preferably, whatever changes are specified by the subscriber take effect promptly—in minutes or hours, rather than days or weeks.

Note that in accordance with the principles of the present invention, an authorization code is generally used to identify a person placing a call, and is not tied to a particular calling device (e.g., a particular telephone or telephone line). As a result, an authorized person may advantageously use his or her code to access the semi-listed number from any telephone. This is quite different than systems based on Caller-ID or ANI (automatic Number Identification), which could possibly authorize a particular device or line for access, but not a particular individual. However, in accordance with one other illustrative embodiment of the invention, the subscriber can in fact choose to associate a given authorization code with a calling number, thereby allowing anyone who places a call from that number to have the appropriate access to the semi-listed number as defined by the action(s) corresponding to the given authorization code.

In accordance with various other illustrative embodiments of the present invention, the action(s) to be taken in response to an authorization code may be dependent on the time and/or the date. For example, an authorization code may permit the call to ring through to the subscriber if it is between 9 AM and 5 PM, but be redirected to a voice mailbox otherwise. In addition, in accordance with various other illustrative embodiments of the present invention, the subscriber can schedule future changes in actions. For example, a subscriber might configure an authorization code to ring through now, but, after, say, one month, the action for that code will automatically change to giving a recorded announcement and then disconnecting. And in accordance with various other illustrative embodiments of the present invention, actions may be usage sensitive. For example, the subscriber might configure an authorization code to ring through now, but after that particular code has been used, say, four times, the action for that code will automatically change to giving a recorded announcement and then redirecting the call to a voice mailbox.

By way of illustration, the following are some possible scenarios for using semi-listed telephone numbers in accordance with various illustrative embodiments-of the present invention. In one such scenario, a subscriber may give different authorization codes to different individuals. Then, if one of these codes become compromised (which may, for example, be evidenced by excessive incoming calls being made with use of that code), the subscriber can invalidate that code, without changing the codes known to other users. (For comparison purposes, note that if a conventional unlisted telephone number is compromised, the subscriber must get a new number from the service provider and give that new number to everyone who had the old one.) Note that if a semi-listed number code is in fact compromised in this scenario, the subscriber will know which individual is responsible (i.e., who compromised the code).

In another one of these scenarios, the initial recorded announcement (heard by all callers) states “Press one to leave a voice mail message.” Then, if “1” (the valid authorization code) is in fact entered, the call would be redirected to the voice mailbox. However, if the authorization code (“1”) is not entered, the default action taken is that the call is immediately disconnected. In this manner, human callers could enter the authorization code to leave a message, but automated dialers (even those that are typically capable of detecting and handling answering machines) will probably not be able to leave a message (unless they are somehow capable of understanding and acting on the instructions being given).

In still another one of these scenarios, a subscriber gives out the basic phone number (without an authorization code) to all potential callers, but gives out the number and an authorization code to selected individuals. Thus, if the valid authorization code enables a ring through, but the failure of a caller to enter a valid authorization code redirects the call to a voice mailbox, then all callers can leave a message but only the selected set of callers can get through to the subscriber. Such a capability is not possible with conventional unlisted phone numbers.

And in yet another one of these scenarios, “single-use” (or “limited-use”) authorization codes may be provided when the subscriber wants to give certain potential callers a “temporary” phone number. For example, suppose that a subscriber calls a plumber and gets the plumber's answering machine. The subscriber can leave a message on the plumber's answering machine which provides his or her base telephone number plus an authorization code which has been configured by the subscriber to expire after one use (or after a limited number of uses).

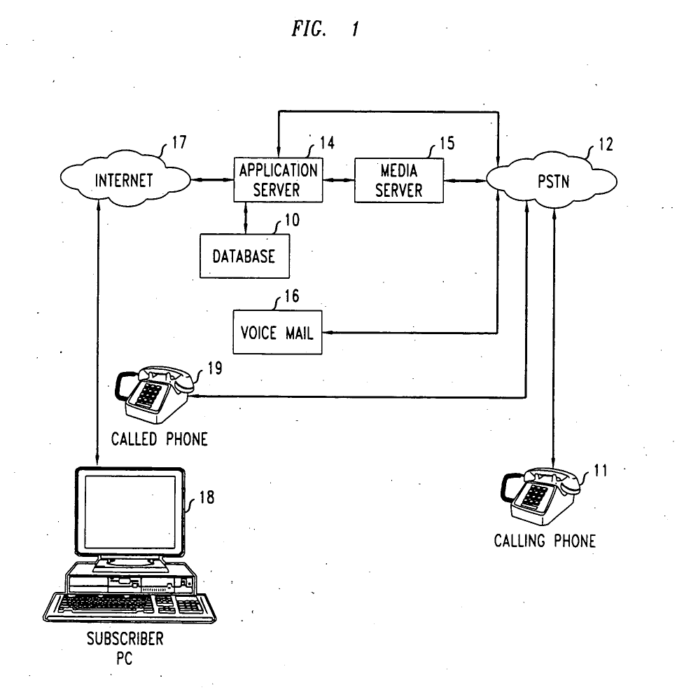

FIG. 1 shows an example telecommunications network in which an illustrative embodiment of the present invention may be advantageously implemented. In operation of the illustrative network of FIG. 1, a user first subscribes to the semi-listed telephone number service with his or her service provider, receives a conventional phone number, and then uses subscriber PC (Personal Computer) 18, via (public) Internet 17, to create an initial setup of authorization codes and actions to be associated therewith. This information is advantageously stored by application server 14 in database 10.

Then, when a call is placed from calling phone 11 and directed to called phone 19 (the phone belonging to the subscriber of the semi-listed phone number service), the operation of the illustrative network proceeds as follows. First the call is initiated in a conventional manner through conventional PSTN (Public Switched Telephone Network) 12. As is well known, PSTN 12 contains a plurality of conventional telecommunications switches, which are themselves fully familiar to those of ordinary skill in the art.

Then, in accordance with the principles of the present invention, a switch in PSTN 12 (e.g., the switch which is handling the call for the service provider) recognizes that the called number is the particular phone number (i.e., one which has previously subscribed to the semi-listed number service), and as such, has been indicated by the service provider as a “special” number requiring assistance from application server 14. Thus, the switch advantageously requests instructions for handling the call from application server 14. Then, application server 14 instructs the switch to connect the call to media server 15, which plays a (prerecorded) message to the caller requesting that the caller enter an authorization code or PIN (Personal Identification Number). The caller then enters his or her PIN through calling phone 11 (illustratively, either by pressing the digits on the telephone keypad, or, alternatively, by spoken voice), and media server 15 “collects” the digits of the PIN and transmits them to application server 14 for analysis.

Specifically, application server 14 consults database 10, which, as described above, has been advantageously provided with a list of valid authorization codes (i.e., PINs) and associated actions to be performed in response thereto. If the PIN is found to be invalid (e.g., not found in database 10), application server 14 (through control of media server 15 and/or the switch in PSTN 12 which is handling the call) may perform a previously defined (e.g., by the subscriber) “default” action, which may, for example, comprise playing a message and hanging up on the caller, or alternatively, may comprise routing the call to voicemail system 16. If, however, the PIN is found to be valid, an appropriate action is taken, which may, for example, be specified in database 10 in the entry associated with the particular PIN. This action may, for example, comprise instructing the switch to route the call through to called phone 19, or alternatively, to redirect the call to voicemail system 16.

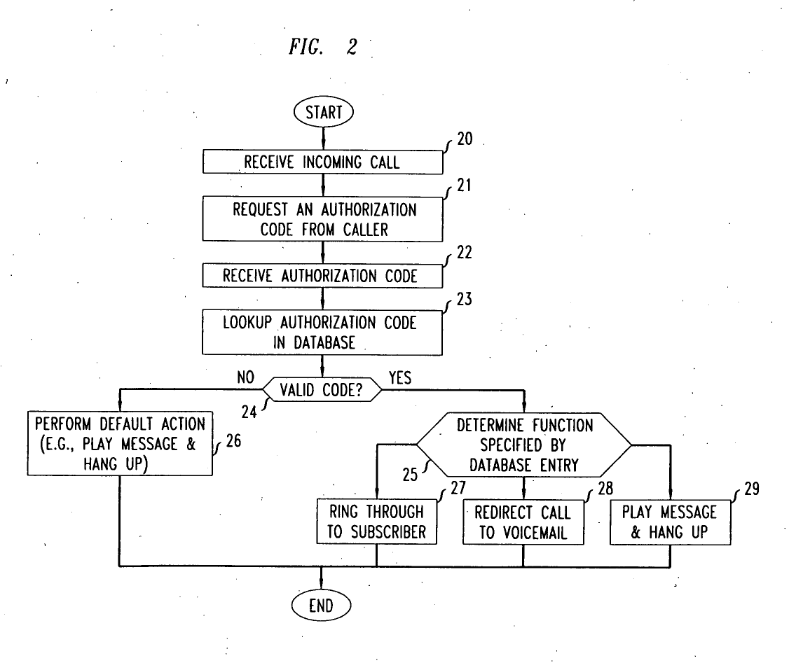

FIG. 2 shows a flowchart specifying a method for performing caller classification in accordance with an illustrative embodiment of the present invention. The operation of the illustrative method for handling a semi-listed number (SLN) begins in block 20 with the receiving of an incoming phone call directed to the SLN. Then, the illustrative SLN method of FIG. 2 requests an authorization code or PIN from the caller in block 21. For example, a prerecorded message may be played to the caller requesting that such a code be entered. The authorization code is received in block 22 and is then looked up in the database (block 23), which has been advantageously set up previously by the SLN subscriber.

If the authorization code provided is not valid, as determined in decision block 24, block 26 performs a default action which may, for example, have been-specified by the subscriber. Illustratively, this default action may comprise playing a message and hanging up on the caller, or alternatively, it may comprise routing the call to a voicemail system. If, on the other hand, the authorization code provided is valid (as determined in decision block 24), decision block 25 determines which particular action should be performed, as illustratively specified in the database entry associated with the provided authorization code. As shown in the illustrative method of FIG. 2, one of three such actions may, for example, have been specified—ringing through to the subscriber (block 27), redirecting the call to a voicemail system (block 28), or playing a prerecorded message and hanging up (block 29).

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. Furthermore, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

Thus, for example, it will be appreciated by those skilled in the art that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

1. A method for performing caller classification of a telecommunications call made to a called party, the method comprising the steps of:
receiving an incoming call from a caller;
receiving an authorization code from the caller; and
performing at least one of a set of predetermined actions, said at least one action having been selected based on the authorization code received from the caller, the set of predetermined actions including at least two different actions selected from the group comprising (i) connecting the incoming call through to the called party, (ii) redirecting the incoming call to a voice mailbox, (iii) providing a recorded message to the caller, and (iv) disconnecting the call,
wherein at least a first authorization code results in performing one of said at least two different actions selected from said group and wherein at least a second authorization code different from said first authorization code results in performing the other one of said at least two different actions selected from said group.

2. The method of claim 1 further comprising the steps of performing a lookup of the authorization code received from the caller in a database, and selecting said at least one action based upon said lookup in said database.

3. The method of claim 2 wherein a predetermined one of said set of predetermined actions is performed when said lookup fails to locate said authorization code received from the caller in said database.

4. The method of claim 3 wherein the step of receiving an authorization code from the caller comprises repeating, up to a predetermined number, N, of times, the steps of:
receiving an authorization code from the caller, and
performing a lookup of the received authorization code in the database, wherein if all of said predetermined number, N, of said repeated lookups of a received authorization code fail to locate the authorization code in the database, the predetermined one of said set of predetermined actions is performed.

5. The method of claim 1 wherein the incoming call is transmitted from the caller through a Public Switched Telephone Network.

6. The method of claim 1 wherein the incoming call is transmitted from the caller as voice-over-IP data through the Internet.

7. The method of claim 1 further comprising the step of playing a prerecorded message in response to receiving said incoming call, the prerecorded message comprising a request that the caller provide said authorization code.

8. The method of claim 1 wherein said authorization code is provided by the caller with use of a telephone keypad.

9. The method of claim 1 wherein said authorization code is provided by the caller with use of a spoken voice.

10. The method of claim 1 wherein the predetermined action of connecting the incoming call through to the called party comprises connecting the incoming call through to the called party with use of a ring tone which is selected from a plurality of possible ring tones based on the authorization code received from the caller.

11. The method of claim 1 wherein the authorization code received from the caller is determined based on a calling number from which the incoming call originates.

12. The method of claim 1 wherein the at least one action is selected further based on a current date.

13. The method of claim 1 wherein the at least one action is selected further based on a current time of day.

14. The method of claim 1 wherein the at least one action is selected further based on a count of a number of times the authorization code received from the caller has been previously received.

15. An apparatus for performing caller classification of a telecommunications call made to a called party, the apparatus comprising an interception module adapted to:
receive an incoming call from a caller;
receive an authorization code from the caller; and
initiate the performance of at least one of a set of predetermined actions, said at least one action having been selected based on the authorization code received from the caller, the set of predetermined actions including at least two different actions selected from the group comprising (i) connecting the incoming call through to the called party, (ii) redirecting the incoming call to a voice mailbox, (iii) providing a recorded message to the caller, and (iv) disconnecting the call,
wherein at least a first authorization code results in performing one of said at least two different actions selected from said group and wherein at least a second authorization code different from said first authorization code results in performing the other one of said at least two different actions selected from said group.

16. The apparatus of claim 15 further comprising a database, and wherein the interception module performs a lookup of the authorization code received from the caller in said database, and selects said at least one action based upon said lookup in said database.

17. The apparatus of claim 15 wherein the interception module is co-located with the subscriber.

18. The apparatus of claim 15 wherein the interception module is located within a telecommunications network.

19. The apparatus of claim 18 wherein the telecommunications network comprises a Public Switched Telephone Network.

20. The apparatus of claim 18 wherein the telecommunications network comprises the Internet and the incoming call is transmitted from the caller through the Internet as voice-over-IP data.

21. The apparatus of claim 15 wherein the interception module is further adapted to play a prerecorded message in response to receiving said incoming call, the prerecorded message comprising a request that the caller provide said authorization code.

22. The apparatus of claim 15 wherein said authorization code is provided by the caller with use of a telephone keypad.

23. The apparatus of claim 15 wherein said authorization code is provided by the caller with use of a spoken voice.

24. The apparatus of claim 15 wherein the authorization code received from the caller is determined based on a calling number from which the incoming call originates.
